(19) United States
(12) Patent Application Publication
(10) Pub. No.: US 2008/0094947 A1
(43) Pub. Date: Apr. 24, 2008

(54) Optical Disc Device for Recording and Reproducing

(75) Inventors: Petrus Theodorus Jutte, Eindhoven (NL); Johannes Joseph Hubertina Barbara Schleipen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,265

(22) PCT Filed: Jul. 12, 2005
(86) PCT No.: PCT/IB05/52306

§ 371 Date: Jan. 18, 2007

(30) Foreign Application Priority Data
Jul. 21, 2004 (EP) 04300452.2

(51) Int. Cl. G11B 7/09

(52) U.S. Cl. 369/44.11

(57) ABSTRACT

An optical scanning device for scanning an information carrier comprising tracks with a track pitch q, the closest track to the center of the information carrier having a radius r. The optical scanning device comprises a radiation source for generating a radiation beam and means for generating three spots on the information carrier from said radiation beam. The means for generating three spots are arranged in such a way that the distance s between two consecutive spots on he information carrier is such that equation (I) where s and q are in micrometers and r in millimeters, r is inferior to 10 millimeters and α is superior to 0.2.

### FIELD OF THE INVENTION

The present invention relates to an optical device, in particular an optical device for scanning a small form factor information carrier.

### BACKGROUND OF THE INVENTION

In an optical scanning device for scanning an information carrier comprising tracks, it is important to ensure that a scanning spot remains on the track being scanned. To this end, radial tracking error detection is performed. A radial tracking error signal is measured, and a control loop is used in order to modify the position of the scanning spot on the information carrier, such that the scanning spot remains on the center of the track being scanned. A conventional radial tracking method is the so-called three spots push-pull or differential push-pull radial tracking method.

Patent application US 2002/0185585 describes an optical scanning device comprising means for performing the three spots push-pull radial tracking method. Such an optical scanning device is depicted in FIG. 1. This optical scanning device comprises a polarized radiation source 101, a grating 102, a polarizing beam splitter 103, a collimator 104, a folding mirror 105, an objective lens 106, a quarter wave plate 107 and a three-spots detector module 108. This optical scanning device is intended for scanning an information carrier 100. The radiation source 101 generates a radiation beam, from which three spots are generated by means of the grating 102. The three spots pass through the polarizing beam splitter 103 and through the collimator 104 before being reflected towards the information carrier 100 by means of the folding mirror 105. They are then focused on the information carrier 100 by means of the objective lens 106. On reflection from the disc, the three spots are reflected by the beam splitter 103 towards the three-spots detector module 108, because they have a polarization orthogonal to the polarization of the radiation beam generated by the radiation source 101, due to the presence of the quarter wave plate 107 in the optical path.

FIG. 2 shows the three-spots detector module 108. It comprises a first detector array 108a, a second detector array 108b and a third detector array 108c. The width of a detector array is Δd and two consecutive detectors are separated by a distance Δs. The first detector array 108a comprise two detectors A1 and A2, the second detector array comprises four detectors C1, C2, C3 and C4 and the third detector 108c comprises two detectors B1 and B2. The first and third detector arrays 108a and 108c are called satellite detector arrays, whereas the second detector array 108b is called the central detector array. The three spots on the three detector arrays are also shown in FIG. 2. FIG. 2 corresponds to the situation where the central spot is focused on a track. In this case, the central spot is focused in the center of the central detector array and the two satellite spots are focused on the centers of the two satellite detector arrays.

The radial error signal RE is defined as

$$RE = \frac{C 1 - C 2 - C 3 + C 4 - γ ( A 1 - A 2 + B 1 - B 2 )}{C 1 + C 2 + C 3 + C 4 + γ ( A 1 + A 2 + B 1 + B 2 )}$$

where C1 corresponds to the signal on the detector C1, C2 to the signal on the detector C2, and so on. When the central spot is focused on the track being scanned, the radial error signal is null. However, when the central spot is not focused on the track being scanned, the radial error signal is not null. This property is used in order to move the objective lens 106 radially until the central spot is focused on the track being scanned.

In a typical optical scanning device, a so-called Y-error misalignment occurs. Actually, the movement of the objective lens 106 during tracking is not always perpendicular to the tracks, because of a misalignment of the axis along which the objective lens 106 is moved with respect to a direction perpendicular to the tracks. This results in a so-called static Y-error misalignment. Moreover, a dynamic Y-error misalignment also occurs during rotation of the information carrier, due to eccentricity and ellipticity of the tracks.

It has been shown that the Y-error misalignment leads to a reduction of the radial error signal, which reduction is equal to

$$\frac{2}{( 1 + cos ( 2 π \frac{sY}{Rq} )}$$

where s is the distance between two consecutive spots on the disc, i.e. between the central spot and a satellite spot, Y is the Y-error misalignment, R is the radius of the track being scanned and q is the track pitch. Now, the radial error signal should be large enough in order to allow detection of the radial error and thus allow correction of the radial position of the objective lens 106. A high Y-error misalignment leads to a reduction of the radial error signal, which may alter the radial tracking. This is even more important when the radius of the track being scanned is small.

### SUMMARY OF THE INVENTION

It is an object of the invention to provide an optical scanning device in which the radial tracking is less sensitive to the Y-error misalignment.

To this end, the invention proposes an optical scanning device for scanning an information carrier comprising tracks with a track pitch q, the closest track to the center of the information carrier having a radius r, the optical scanning device comprising a radiation source for generating a radiation beam, means for generating three spots on the information carrier from said radiation beam, said means for generating three spots being arranged in such a way that the distance s between two consecutive spots on the information carrier is such that

$$s \leq \frac{10 \sqrt{1 - α}}{π} rq ,$$

where s and q are in micrometers and r in millimeters, r is inferior to 10 millimeters and α is superior to 0.2.

As will be explained in details in the description, the reduction of the radial error signal in an optical scanning device in accordance with the invention is less than 1/α. Hence, the radial error signal is reduced by a factor inferior to 5, which is acceptable for allowing a robust radial tracking. Preferably, α is superior to 0.5. In this case, the radial error signal is reduced by a factor inferior to 2, and the radial tracking is even more robust.

The invention takes into account the fact that the amplitude of the radial error signal depends on the radius of the track being scanned. In conventional optical discs, such as CD and DVD, the first track, i.e. the track that is closest to the center of the disc, has a relatively large radius, such as 30 millimeters. As a consequence, a CD or DVD player and/or recorder is not very sensitive to Y-error misalignments. However, for smaller discs, which are currently under development, the inner radius, i.e. the radius of the track that is closest to the center of the disc, is relatively small, such as inferior to 10 millimeters. There is thus a need to reduce the influence of the Y-error misalignments on the radial tracking error signal. This is achieved in that the distance between the central spot and a satellite spot on the information carrier is reduced.

### BRIEF DESCRIPTION OF THE DRAWINGS

The invention will now be described in more detail by way of example with reference to the accompanying drawings, in which:

FIG. 1 shows an optical scanning device in accordance with the prior art;

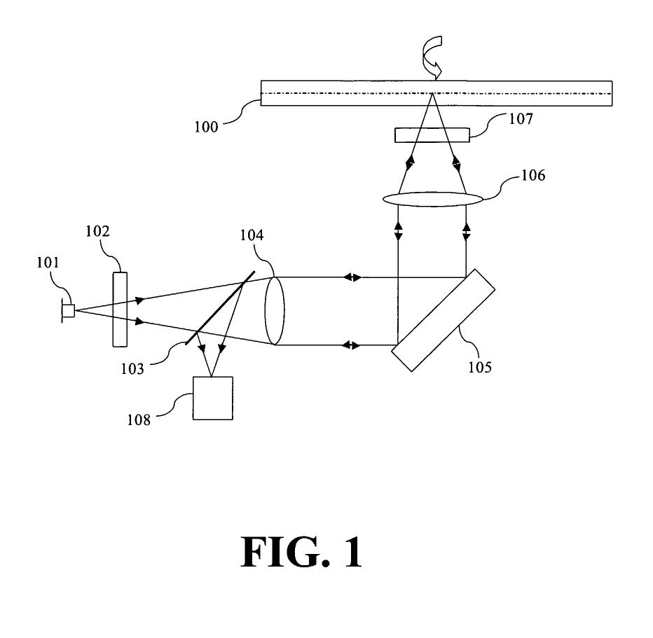

FIG. 2 shows the three-spots detector module of the optical scanning device of FIG. 1;

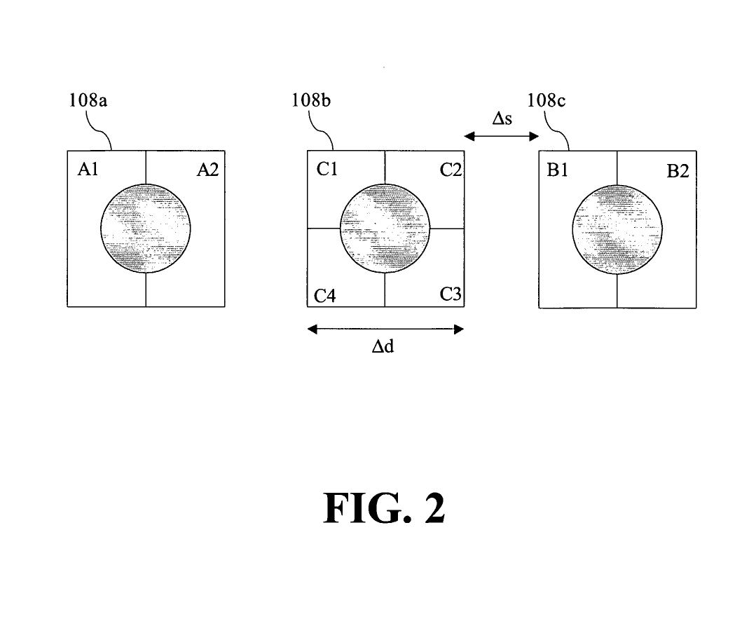

FIG. 3 shows the first tracks of an information carrier and three spots focused on said information carrier by means of an optical scanning device in accordance with the invention;

FIG. 4 shows a focus s-curve measured by means of an optical scanning device in accordance with the invention.

### DETAILED DESCRIPTION OF THE INVENTION

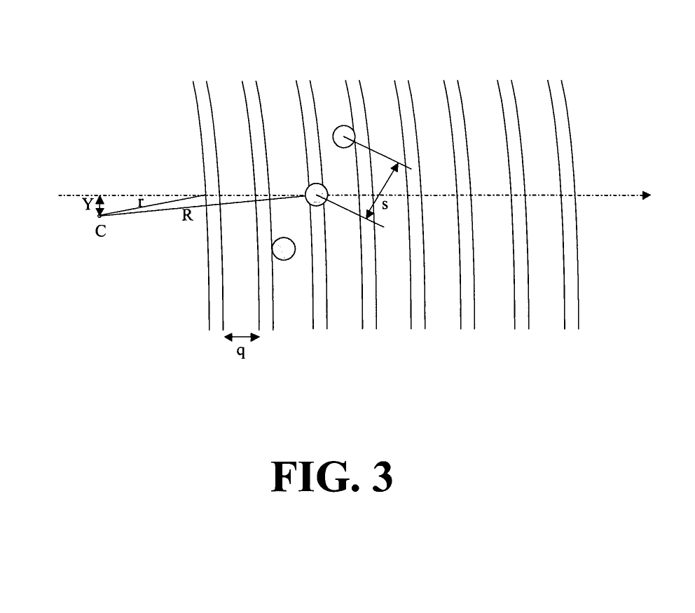

FIG. 3 shows the first tracks of an information carrier intended to be scanned by an optical device in accordance with the invention. The information carrier comprises a center C, and a first track having a radius r. The first track, which is the closest track to the center C, corresponds to the first track where information is recorded or can be recorded. The information carrier comprises other tracks, which radiuses are noted R, R varying from r to the outer radius of the information carrier.

In FIG. 3, the direction of the objective lens 106 during tracking is represented by a dotted arrow. As can be seen, this direction does not pass through the center C, which means that it is not perpendicular to the tracks of the information carrier. This leads to a static Y-error misalignment Y, which is shown in FIG. 3. The Y-error misalignment also comprises a dynamic Y-error misalignment, which mainly depends on the information carrier being scanned. The Y-error misalignment is the sum of the static and dynamic Y-error misalignments. A typical value for the Y-error misalignment is 100 micrometers. In the following, the Y-error misalignment is taken equal to 100 micrometers, which is a mean value of the Y-error misalignments that can be measured in a plurality of optical scanning devices. However, the invention is not limited to optical scanning devices where the Y-error misalignment is 100 micrometers, because the Y-error misalignment varies from one optical device to another, and also from one information carrier being scanned to another.

The distance between two consecutive spots on the information carrier is s. The object of this invention is to reduce the distance s between two consecutive spots as compared with

conventional optical scanning devices. If s is chosen in such a way that

$$s \leq \frac{10 \sqrt{1 - α}}{π} rq , then$$

$$1 - {( \frac{π Y \cdot s}{rq} )}^{2} > α ,$$

where Y is chosen equal to 100 micrometers. This leads to

$$\frac{1 + [ 1 - \frac{1}{2} {( 2 π \frac{Y \cdot s}{rq} )}^{2} ]}{2} > α ,$$

which, with a Taylor expansion, leads to

$$\frac{2}{( 1 + cos ( 2 π \frac{sY}{Rq} )} < \frac{1}{α} .$$

As a consequence, the reduction of the radial error signal in an optical scanning device in accordance with the invention is less than 1/α. This means that when a is superior to 0.2, the reduction of the radial error signal is less than 5, which is enough for ensuring a robust radial tracking.

Typical values for a small form factor optical disc are r=6 mm and q=0.5 μm. In order to have a reduction of the radial error signal inferior to 2, the distance s between two consecutive spots on the information carrier should be inferior to 9 micrometers.

It should be noted that the invention also provides a relative small variation of the slope of the radial error signal. Reducing the distance between two consecutive spots on the information carrier reduces the variation of the slope of the radial error signal. This is particularly advantageous, because a small variation of the slope of the radial error signal improves the radial tracking servo control loop.

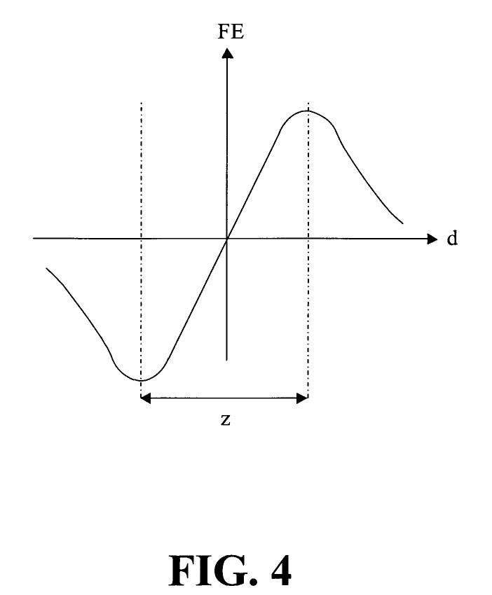

FIG. 4 shows a focus s-curve measured by means of an optical scanning device in accordance with the invention. The focus s-curve measures a focus error signal FE as a function of the distance d between the objective lens 106 and the information carrier 100. A parameter that can be measured is the focus s-curve length z. It has been shown that the relation between the focus s-curve length z and the distance s between two consecutive spots on the information carrier is

$$s = 2 \sqrt{2} \cdot z \cdot NA \cdot ( 1 + \frac{Δ s}{Δ d} ) .$$

### As a consequence, choosing the distance s between two consecutive spots on the information carrier in such a way that

$$s \leq \frac{10 \sqrt{1 - α}}{π} rq$$

is equivalent to designing the optical scanning device in such a way that

$$z \leq \frac{5 \sqrt{\frac{1 - α}{2}}}{π NA ( 1 + \frac{Δ s}{Δ d} )} rq .$$

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical scanning device for scanning an information carrier comprising tracks with a track pitch q, the closest track to the center of the information carrier having a radius r, the optical scanning device comprising a radiation source for generating a radiation beam, means for generating three spots on the information carrier from said radiation beam, said means for generating three spots being arranged in such a way that the distance s between two consecutive spots on the information carrier is such that
$$s \leq \frac{10 \sqrt{1 - α}}{π} rq ,$$
where s and q are in micrometers and r in millimeters, r is inferior to 10 millimeters and α is superior to 0.2.

2. An optical scanning device as claimed in claim 1, wherein a is superior to 0.5.

3. An optical scanning device for scanning an information carrier comprising tracks with a track pitch q, the closest track to the center of the information carrier having a radius r, the optical scanning device comprising a radiation source for generating a radiation beam, an objective lens having a numerical aperture NA, three detectors for measuring a focus s-curve, the detectors having a width Δd and being separated by a distance Δs, said focus s-curve having a focus s-curve z such that
$$z \leq \frac{5 \sqrt{\frac{1 - α}{2}}}{π NA ( 1 + \frac{Δ s}{Δ d} )} rq ,$$
where z and q are in micrometers and r in millimeters, r is inferior to 10 millimeters and α is superior to 0.2.

4. An optical scanning device as claimed in claim 3, wherein a is superior to 0.5.
